(19) United States
(12) Patent Application Publication
(10) Pub. No.: US 2007/0031231 A1
(43) Pub. Date: Feb. 8, 2007

(54) Gas cylinder lift

(76) Inventor: Roy David Powell, Salisbury, NC (US)

Correspondence Address: LITMAN LAW OFFICES, LTD, PO BOX 15035, CRYSTAL CITY STATION, ARLINGTON, VA, 22215, US

(21) Appl. No.: 11/332,140

(22) Filed: Jan. 17, 2006

Related U.S. Application Data
(60) Provisional application No. 60/705,464, filed on Aug. 5, 2005.

(51) Int. Cl. B66F 9/10

(52) U.S. Cl. 414/629

(57) ABSTRACT

The gas cylinder lift is a hydraulic jack mounted on a frame and secured to a mobile cart. The jack lifts a support post, which is guided by a slot running vertically up a guide post. A bucket connected to the bottom of the support post is adapted to hold heavy welding machine gas cylinders or other similar containers. A safety chain or line secured at the top of the support post, and another safety line in the form of an elastic cable or bungee cord, along the bucket help stabilize the cylinders during transport. A safety bolt locks the support post to the guide post during transport to prevent the support post and bucket from moving. Other items, such as welding accessories, may be transported on the cart platform.

### CROSS-REFERENCE TO RELATED APPLICATION

This application claims the benefit of U.S. Provisional Patent Application Ser. No. 60/705,464, filed Aug. 5, 2005.

### BACKGROUND OF THE INVENTION

1. Field of the Invention

The present invention relates to lifting jacks and carts and more specifically, to a cart and hydraulic jack used in lifting and transporting gas cylinders.

2. Description of the Related Art

The welding fuel used in portable welding machines is commonly stored in large, cylindrical pressure vessels. These cylinders often weigh well over 175 pounds, and, therefore, are difficult for individuals to handle manually. These gas cylinders must be transported to the location of a portable welding machine each time the welding machine is used. Care must be taken not to damage the cylinders, because the contents are under extreme pressure while contained within the cylinders. The gas cylinders must be loaded onto the back of a portable welding machine. A hydraulic slide jack mounted on a welding cart that eliminates the need for “bear hugging” a slick, 175 lb. gas bottle would be desirable.

Portable welding machine operators need a device that will allow them to pick up and transport these cylinders in a safe and easy manner. Thus, a gas cylinder lift solving the aforementioned problems is desired.

### SUMMARY OF THE INVENTION

The gas cylinder lift is a hydraulic jack mounted on a frame and secured to a mobile cart. The jack lifts a support post, which is guided by a slot running vertically up a guide post. The bottom of the guide post is secured to the mobile cart. An upper strut and a lower strut each project out horizontally from the support post. The free end of each strut is disposed within the slot in the guide post. The hydraulic jack supports the upper strut, such that raising and lowering the hydraulic jack raises and lowers the upper strut and, as a result, the support post.

A bucket connected to the bottom of the support post is adapted to hold heavy welding machine gas cylinders and similar containers. The top of the support post can be adapted to receive a safety rope for helping to stabilize the cylinders during transport. An additional safety rope may be connected to the bucket to help secure the lower end of a cylinder in the bucket during transport.

A safety bolt locks the upper strut of the support post to the guide post during transport to prevent the support post and bucket from accidentally moving. The safety bolt passes through an aperture in the upper strut and an aperture in a safety plate that extends out from the guide post. When the safety bolt is removed, the support post may be raised and lowered by the hydraulic jack.

A welding machine may be transported on the mobile cart. A connecting plate secured to the back of the welding machine may be bolted onto a bracket that is secured to the guide post.

These and other features of the present invention will become readily apparent upon further review of the following specification and drawings.

### BRIEF DESCRIPTION OF THE DRAWINGS

FIG. 1 is an environmental, perspective view of a gas cylinder lift according to the present invention.

FIG. 2 is a perspective view of a gas cylinder lift according to the present invention.

FIG. 3 is a partial side view of a gas cylinder lift in a lowered position according to the present invention.

FIG. 4 is a partial side view of a gas cylinder lift in a raised position according to the present invention.

FIG. 5 is a perspective view of an alternate embodiment of a gas cylinder lift according to the present invention.

FIG. 6 is a partial side view of an alternate embodiment of a gas cylinder lift according to the present invention.

Similar reference characters denote corresponding features consistently throughout the attached drawings.

### DETAILED DESCRIPTION OF THE PREFERRED EMBODIMENTS

The present invention is a gas cylinder lift, designated generally as 10 in the drawings.

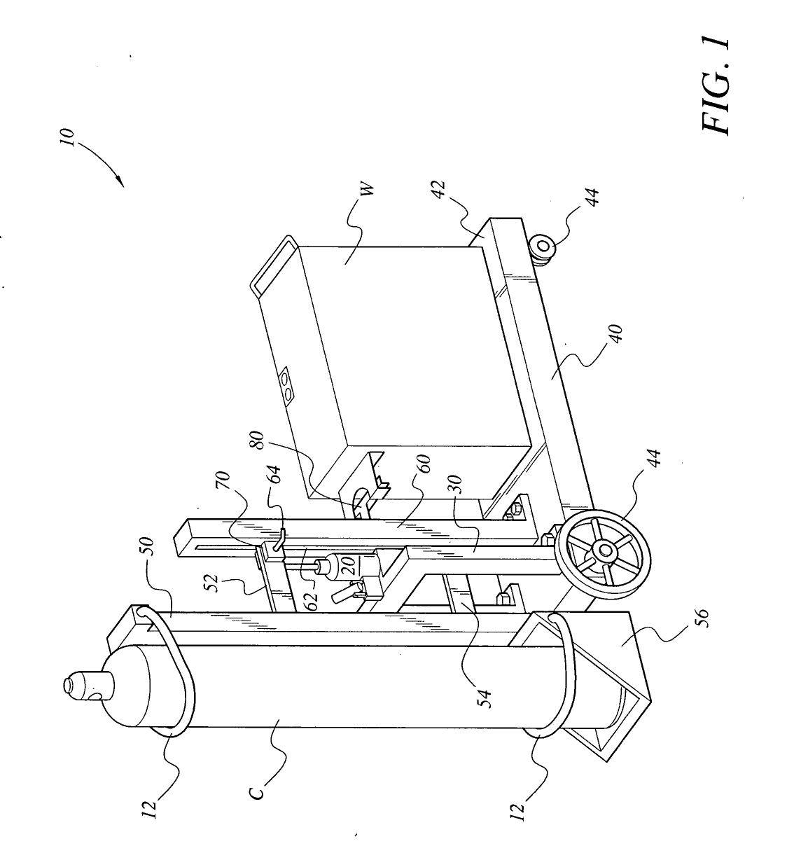

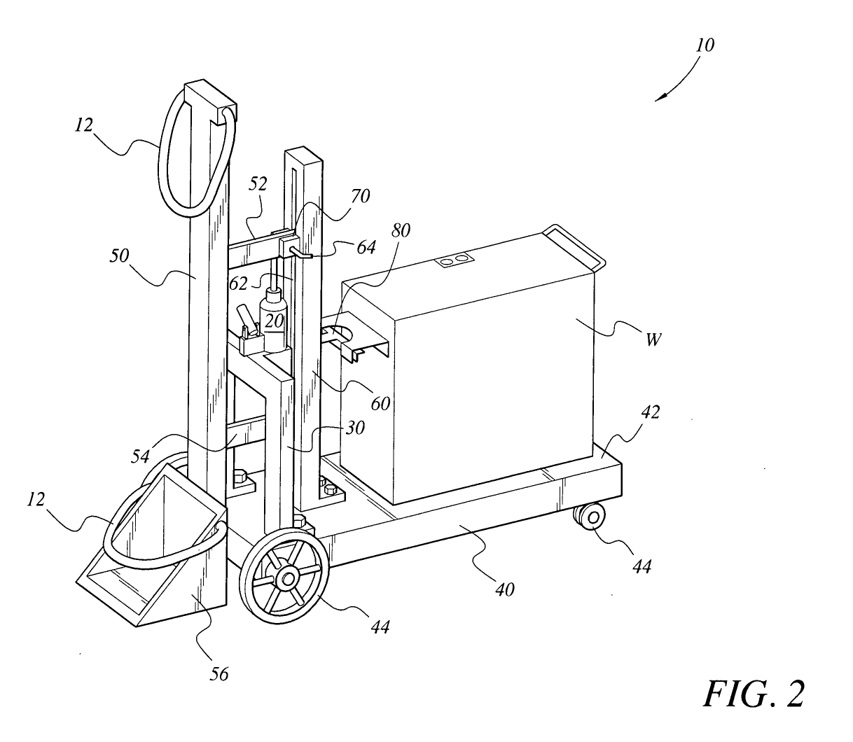

As shown in FIGS. 1 and 2, the gas cylinder lift 10 includes a hydraulic jack 20 mounted on the top of a support frame 30 that extends vertically from the horizontal platform 42 of a mobile cart 40, having wheels 44. Jack 20 controls the vertical movement of vertical support post 50, which is guided by a slot 62 running vertically up vertical guide post 60. The bottom of vertical guide post 60 is secured to horizontal platform 42 of mobile cart 40. An upper strut 52 and a lower strut 54 each project out horizontally from vertical support post 50. The free end of each strut is disposed within slot 62 in vertical guide post 60. The hydraulic jack 20 supports the upper strut 52, such that raising and lowering hydraulic jack 20 raises and lowers the upper strut 52 and, in turn, also vertical support post 50.

A bucket 56 connected to the bottom of vertical support post 50 is adapted to hold a heavy welding machine gas cylinder C or other similar containers. In a preferred embodiment, a top portion of vertical support post 50 is adapted to receive a safety chain or line 12, the safety chain or line 12 being secured to the interior of vertical support post 50 and extending outwardly, allowing the safety chain or line 12 to help stabilize cylinder C during transport. In the preferred embodiment, another safety line (preferably an elastic cable or bungee cord) 12 may additionally be connected to bucket 56 to help secure the lower end of cylinder C in the bucket 56 during transport.

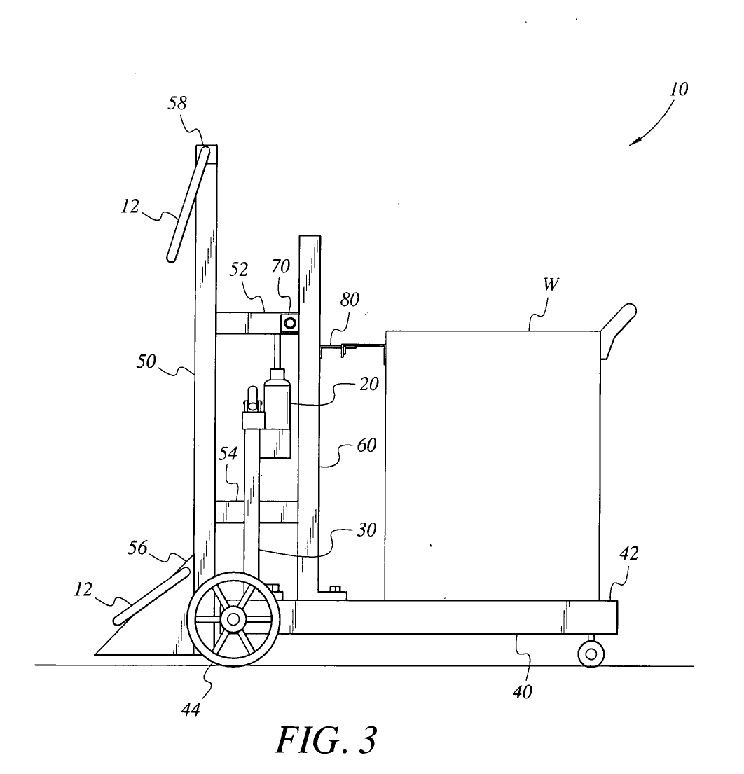

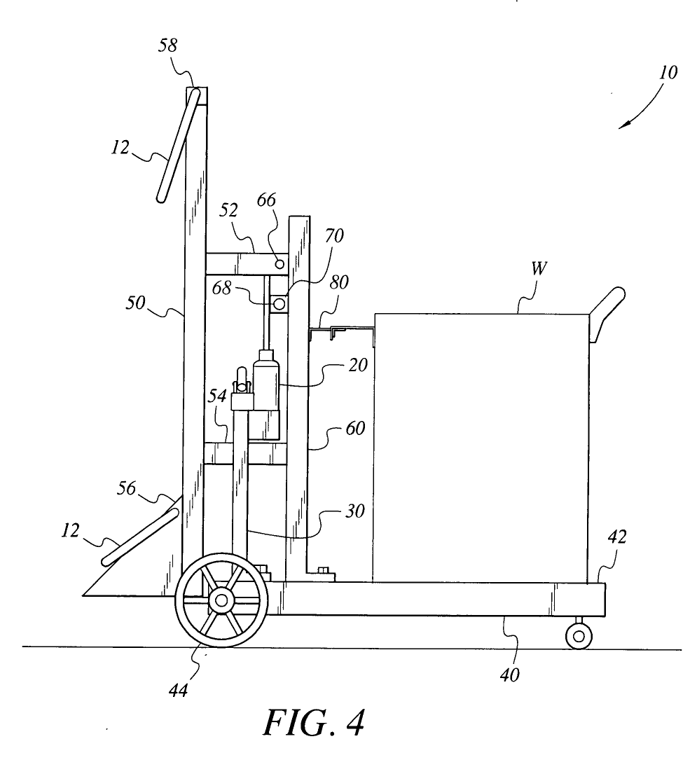

In a preferred embodiment, safety bolt 64 locks upper strut 52 of the vertical support post 50 to the vertical guide post 60 to prevent vertical support post 50 and bucket 56 from moving during transport. As shown in FIGS. 3 and 4, the safety bolt 64 passes through an aperture 66 defined in upper strut 52 and an aperture 68 defined in a safety plate 70 that extends out from vertical guide post 60. When safety bolt 64 is removed, vertical support post 50 may be raised and lowered by hydraulic jack 20.

The mobile cart 40 includes a horizontal platform 42 and a plurality of wheels 44 that allow the cart 40 to be moved easily. Other items, such as a welding machine W, may be transported on horizontal platform 42. A connecting plate secured to the back of welding machine W may be bolted onto a support bracket 80 that is secured to vertical guide post 60.

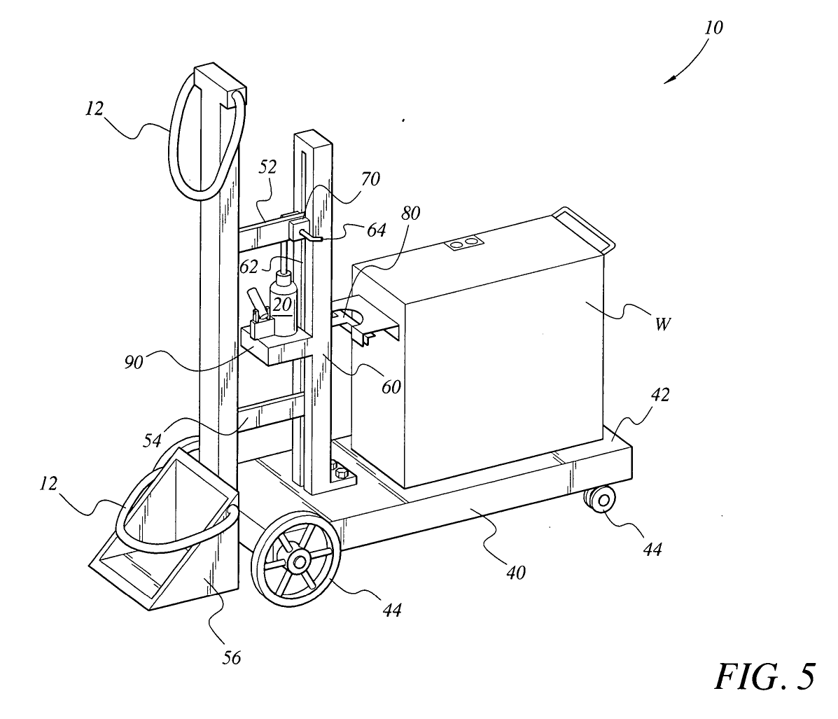

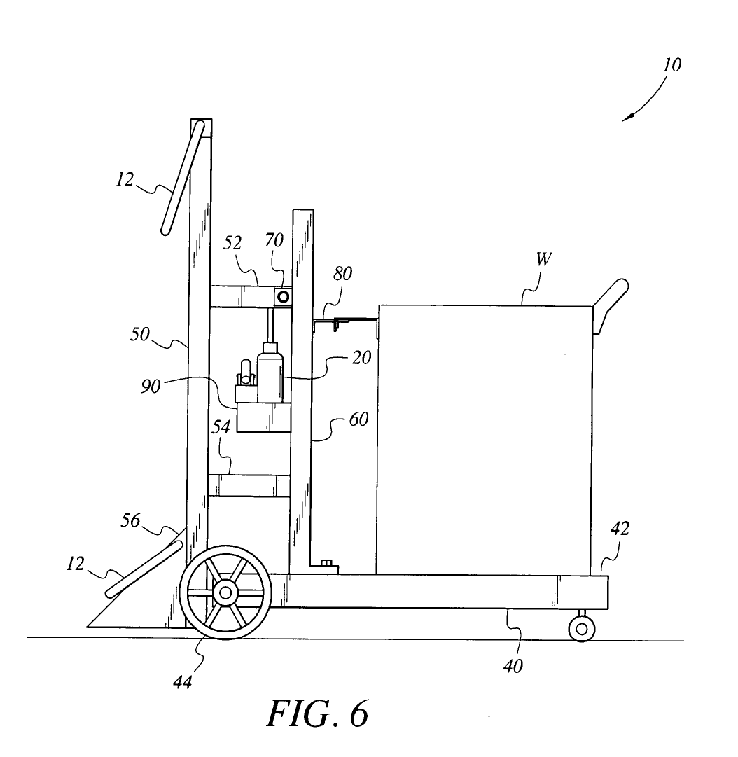

Turning now to FIGS. 5 and 6, an alternate embodiment of gas cylinder lift 10 is shown. Alternate embodiment of gas cylinder lift 10 includes a vertical guide post 60 with a horizontal shelf support 90. Horizontal shelf support 90 supports hydraulic jack 20, which in turn controls the vertical movement of vertical support post 50, which is guided by a slot 62 running vertically up vertical guide post 60. The bottom of vertical guide post 60 is secured to horizontal platform 42 of mobile cart 40. An upper strut 52 and a lower strut 54 each project out horizontally from vertical support post 50. The free end of each strut is disposed within slot 62 in vertical guide post 60. The hydraulic jack 20 supports the upper strut 52, such that raising and lowering hydraulic jack 20 raises and lowers the upper strut 52 and, in turn, also vertical support post 50. A bucket 56 connected to the bottom of vertical support post 50 is adapted to hold a heavy welding machine gas cylinder.

It is to be understood that the present invention is not limited to the embodiments described above, but encompasses any and all embodiments within the scope of the following claims.

I claim:

1. A gas cylinder lift, comprising:
a cart having a horizontal platform and a plurality of wheels secured to the platform;
a support frame extending vertically from the horizontal platform of the cart;
a bucket adapted for holding and lifting a cylindrical container;
a vertical support post secured to the bucket;
an upper strut extending horizontally from the vertical support post;
a hydraulic jack secured to the support frame, wherein the hydraulic jack is configured to raise and lower the upper strut; and
a vertical guide post secured to the cart, the vertical guide post having a guide slot adapted for receiving the upper strut.

2. The gas cylinder lift according to claim 1, further comprising a lower strut extending horizontally from said vertical support post, said lower strut being adapted to be received by said guide slot in said vertical guide post.

3. The gas cylinder lift according to claim 2, wherein the vertical support post is secured in place during movement of the cart by a locking assembly, comprising:
an aperture in the upper strut;
a safety plate extending from the vertical guide post, the safety plate having an aperture, the aperture in the safety plate corresponding to the aperture in the upper strut; and
a safety bolt, the safety bolt extending through the aperture in the safety plate and the aperture in the upper strut when they are in an aligned position.

4. The gas cylinder lift according to claim 2, further comprising at least one safety line, the at least one safety line being attached to vertical support post and attached bucket for securing the cylindrical container in place during movement of the cart.

5. The gas cylinder lift according to claim 2, further comprising a support bracket, the support bracket being attached to the vertical guide post for securing an item in place on the horizontal platform of the cart.

6. A gas cylinder lift, comprising:
a cart having a horizontal platform and a plurality of wheels secured to the platform;
a bucket adapted for holding and lifting a cylindrical container;
a vertical support post secured to the bucket;
an upper strut extending horizontally from the vertical support post;
a vertical guide post secured to the cart, the vertical guide post having a guide slot adapted for receiving the upper strut, the vertical guide post having a horizontal support shelf; and
a hydraulic jack secured to horizontal support shelf of the vertical guide post, wherein the hydraulic jack is configured to raise and lower the upper strut.

7. The gas cylinder lift according to claim 6, further comprising a lower strut extending horizontally from said vertical support post, said lower strut being adapted to be received by said guide slot in said vertical guide post.

8. The gas cylinder lift according to claim 6, wherein the vertical support post is secured in place during movement of the cart by a locking assembly, comprising:
an aperture in the upper strut;
a safety plate extending from the vertical guide post, the safety plate having an aperture, the aperture in the safety plate corresponding to the aperture in the upper strut; and
a safety bolt, the safety bolt extending through the aperture in the safety plate and the aperture in the upper strut when they are in an aligned position.

9. The gas cylinder lift according to claim 6, further comprising at least one safety line, the at least one safety line being attached to vertical support post and attached bucket for securing the cylindrical container in place during movement of the cart.

10. The gas cylinder lift according to claim 6, further comprising a support bracket, the support bracket being attached to the vertical guide post for securing an item in place on the horizontal platform of the cart.

11. A gas cylinder lift, comprising:
a cart having a horizontal platform and a plurality of wheels secured to the platform;
a support frame extending vertically from the horizontal platform of the cart;
a bucket adapted for holding and lifting a cylindrical container;
a vertical support post secured to the bucket;
an upper strut extending horizontally from the vertical support post;
a lower strut extending horizontally from said vertical support post;
a hydraulic jack secured to the support frame, wherein the hydraulic jack is configured to raise and lower the upper strut;
a vertical guide post secured to the cart, the vertical guide post having a guide slot adapted for receiving the upper strut and the lower strut;
a locking assembly having an aperture in the upper strut, a safety plate extending from the vertical guide post, the safety plate having an aperture, the aperture in the safety plate corresponding to the aperture in the upper strut, and a safety bolt, the safety bolt extending through the aperture in the safety plate and the aperture in the upper strut when they are in an aligned position; and
at least one safety line, the at least one safety line being attached to vertical support post and attached bucket for securing the cylindrical container in place during movement of the cart.

12. The gas cylinder lift according to claim 11, further comprising a support bracket, the support bracket being attached to the vertical guide post for securing an item in place on the horizontal platform of the cart.
